(19) United States
(12) Patent Application Publication
(10) Pub. No.: US 2020/0152136 A1
(43) Pub. Date: May 14, 2020

(54) DISPLAY DEVICE INCLUDING A FOLDING AREA COMPENSATOR AND A DRIVING METHOD INCLUDING THE SAME

(71) Applicant: SAMSUNG DISPLAY CO., LTD., Yongin-Si (KR)

(72) Inventor: JAE-HYEON JEON, Seoul (KR)

(21) Appl. No.: 16/677,142

(22) Filed: Nov. 7, 2019

(30) Foreign Application Priority Data
Nov. 8, 2018 (KR) 10-2018-0136514

(51) Int. Cl. G09G 3/3291; G09F 9/30

(52) U.S. Cl. CPC G09G 3/3291; G09F 9/301

(57) ABSTRACT

A display device includes a display panel including a folding area and a non-folding area, a data driver configured to provide a data voltage to the display panel, a gate driver configured to provide a gate signal to the display panel, a folding area compensator configured to generate a compensation data that adjusts a luminance of the folding area based upon a count of the number of times the folding area has been folded and a current flowing through a pixel formed in the folding area, and a timing controller configured to generate a control signal that controls the data driver, the gate driver, and the folding area compensator.

### CROSS-REFERENCE TO RELATED APPLICATION

This application claims priority under 35 USC § 119 to Korean Patent Application No, 10-2018-0136514, filed on Nov. 8, 2018 in the Korean Intellectual Property Office (KIPO), the content of which is incorporated by reference herein in its entirety.

### TECHNICAL FIELD

The present inventive concept relates to a display device, and more particularly, to a display device including a folding area compensator and a driving method including the same.

### DESCRIPTION OF RELATED ART

Flat panel display (FED) devices are, widely used as a display device in electronic devices because FPD devices are relatively lightweight and thin compared to cathode-ray tube (CRT) display devices. Examples of FPD devices are liquid crystal display (LCD) devices, field emission display (FED) devices, plasma display panel (PDP) devices, and organic light emitting display (OLED) devices. OLED devices have been highlighted as the next-generation of display devices because they have a wide viewing angle, a rapid response speed, low thickness, low power consumption, etc.

A foldable display device has also been developed which can be folded carried, and unfolded again to view an image. The foldable display device may provide visual information to a user through a folding area and a non-folding area of a display panel. As a number of times a folding area is folded increases, an efficiency of the pixels formed in the folding area is reduced due to stress incurred by the folding area.

### SUMMARY

According to an exemplary embodiment of the present inventive concept, a display device may include a display panel including a folding area and a non-folding area, a data driver configured to provide a data voltage to the display panel, a gate driver configured to provide a gate signal to the display panel, a folding area compensator configured to generate a compensation data that adjusts luminance of the folding area based upon a count of the number of times the folding area of the display panel has been folded and a current flowing through a pixel formed in the folding area, and a timing controller configured to generate a control signal that controls the data driver, the gate driver, and the folding area compensator.

According to an exemplary embodiment of the present inventive concept, the folding area compensator may include a first storage unit configured to store a luminance change rate of the folding area corresponding to a predetermined reference folding number, a folding sensor configured to sense when the folding area is folded, and a second storage unit configured to update a count of the number of times the folding area has been folded.

According to an exemplary embodiment of the present inventive concept, the folding area compensator may include a compensation data generator configured to generate the compensation data based on a luminance change rate corresponding to the reference folding number when a count of the number of times the folding area has been folded reaches the reference folding number.

According to an exemplary embodiment of the present inventive concept, the first storage unit may include a lookup table (LUT).

According to an exemplary embodiment of the present inventive concept, the folding area compensator may include a current sensor configured to sense the current flowing through the pixels formed in the folding area when a count of the number of times the folding area has been folded reaches the reference folding number, and, a current change rate calculator configured to calculate a current change rate based on an initialization current flowing through the pixels formed in the folding area and the current.

According to an exemplary embodiment of the present inventive concept, the folding area compensator may include a compensation data generator configured to generate the compensation data based upon the preset luminance change rate corresponding to the reference folding number and the current change rate.

According to an exemplary embodiment of the present inventive concept, the compensation data generator may generate the compensation data based upon the current change rate when the luminance change rate is not the same value as the current change rate.

According to an exemplary embodiment of the present inventive concept, the current sensor may sense the current flowing through a part of the pixels formed in the folding area.

According to an exemplary embodiment of the present inventive concept, the current sensor may sense the current flowing through all of the pixels formed in the folding area.

According to an exemplary embodiment of the present inventive concept, the data driver may generate the data voltage based on the compensation data.

According to an exemplary embodiment of the present inventive concept, the compensation data may change voltage level of the data voltage provided to the pixel formed in the folding area.

According to an exemplary embodiment of the present inventive concept, the folding area compensator may be coupled to the data driver.

According to an exemplary embodiment of the pre vent inventive concept, the folding area compensator may be located in the data driver.

According to an exemplary embodiment of the present inventive concept, a driving method of a display device may include an operation of sensing whether the display panel that includes a folding, area and a non-folding area is folded, an operation of updating the count of the number of times the folding area has been folded, and an operation of generating a compensation data that adjusts luminance of the folding area based on a preset luminance change rate corresponding to a reference folding number when the count of the number of times the folding, area has been folded reaches the reference folding number.

According to an exemplary embodiment of the present inventive concept, the luminance change rate corresponding to the reference folding number may be stored in a first storage unit and the number of times of the folding of the folding area is stored in a second storage n it.

According to an exemplary embodiment of the present inventive concept, the first storage unit may include a lookup table (LUT).

According to an exemplary embodiment of the present inventive concept, the driving method of the display device further include an operation of sensing a current flowing through the pixels formed in the folding area when the count of the number of times the folding area has been folded reaches the reference folding number, and an operation of calculating a current change rate based on an initialization current flowing through the pixels formed in the folding area and the current.

According to an exemplary embodiment of the present inventive concept, the operation of generating the compensation data may include generating the compensation data based upon the luminance change rate corresponding to the reference folding number and the current change rate.

According to an exemplary embodiment of the present inventive concept, the operation of generating the compensation data may generate the compensation data based on the current change rate when the luminance change rate and the current change rate, are not the same value.

According to an exemplary embodiment of the present invention, a system for driving a display device is provided that includes a folding area compensator configured to connect to a data driver and a timing controller of a display device. The folding area compensator includes a sensor configured to detect when a folding area is folded based upon a predetermined angle or angle range, and transmits each fold occurrence to a first non-volatile memory device. The first nonvolatile memory device is configured to update a count of the number of folds of the folding area and transmit a signal to a current sensor upon achieving a count of the number of folds that correspond to a predetermined reference number. The current sensor comprises a sensing transistor coupled to a pixel and a sensing line, and the sensing line is configured to provide a sensing signal to the sensing transistor. The sensing transistor is configured to detect current flowing through an organic light emitting diode of the pixel, and the folding area compensator prompts the data driver to release a compensation voltage when the current detected is different from an initial current.

### BRIEF DESCRIPTION OF THE DRAWINGS

The above and other features of the present inventive concept will be more clearly understood by describing in detail exemplary embodiments thereof with reference to the accompanying drawings, in which

FIG. 1 is a block diagram illustrating a display device according to an exemplary embodiment of the present inventive concept;

FIGS. 2A through 2C are perspective views illustrating a display panel included in the display device of FIG. 1 according to an exemplary embodiment of the present inventive concept;

FIG. 3 is a block diagram illustrating a folding area compensator included in the display device depicted in FIG. 1 according to an exemplary embodiment of the present inventive concept;

FIG. 4 is a diagram illustrating a first storage unit included in the folding area compensator of FIG. 3 according to an exemplary embodiment of the present inventive concept;

FIG. 5 is a block diagram illustrating another folding area compensator included in the display device depicted in FIG. 1 according to an exemplary embodiment of the present inventive concept;

FIG. 6 is a circuit diagram illustrating a pixel included in the display panel of the display device of FIG. 1 according to an exemplary embodiment of the present inventive concept;

FIG. 7 is a flowchart illustrating a method of driving the display device according to an exemplary embodiment of the present inventive concept; and

FIG. 8 is a flowchart illustrating a driving method of the display device according to a exemplary embodiment of the present inventive concept.

### DETAILED DESCRIPTION OF THE EMBODIMENTS

Hereinafter, exemplary embodiments of the present inventive concept will be described in detail with reference to the accompanying drawings. The term “change rate” used hereafter may refer to a percentage difference between a current value (preset or actual) and an initial reference value.

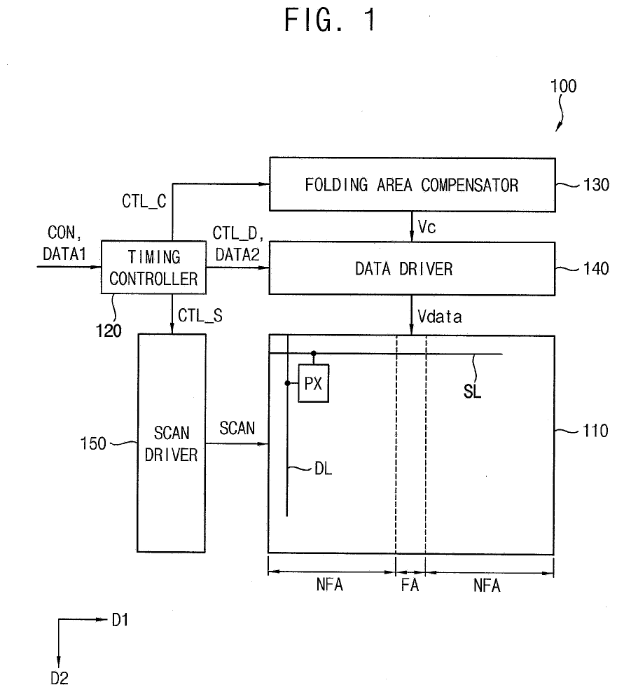

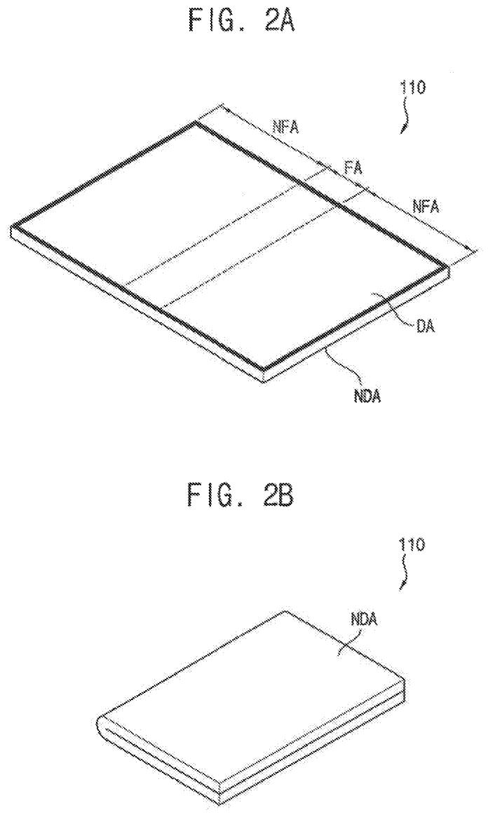

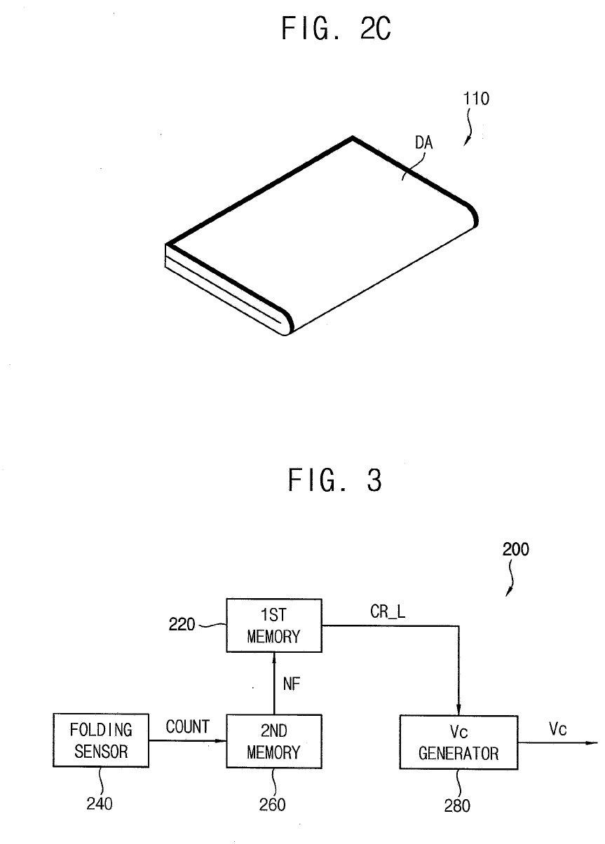

FIG. 1 is a block diagram illustrating a display device according to an exemplary embodiment of the present inventive concept. FIGS. 2A through 2C are perspective views illustrating a display panel included in the display device of FIG. 1.

Referring to FIG. 1, a display device 100 may include a display panel 110, a data driver 140, a scan driver 150, a folding area compensator 130, and a timing controller 120.

The display panel 110 may include data lines DL, scan lines SL, and a plurality of pixels PX. The scan lines SL may extend in a first direction D1 and may be spaced apart from another in a second direction D2 that is perpendicular to the first direction D1. The data lines DL may extend a second direction D2 and may be spaced apart from one another in the first direction D1. The first direction D1 may be parallel to a long side of the display panel 110, and the second direction 132 may be parallel to a short side of the display panel 110. Each of the pixels PX may be formed adjacent to intersection regions of the data lines DL and the scan lines SL. According to an exemplary embodiment of the present inventive concept, each of the pixels PX may include a thin film transistor electrically coupled to the scan line SL and the data line DL a storage capacitor coupled to the thin film transistor, a driving transistor coupled to the storage capacitor, and an organic light emitting diode. The display panel 110 may be an organic light emitting display panel and the display device 100 may be an organic light emitting display device. According to exemplary embodiments of the present inventive concept, each of the pixels PX may include a thin film transistor electrically coupled to the scan line SL and the data line DL, a liquid crystal capacitor and a storage capacitor coupled to the thin film transistor. Thus, the display panel 110 may be a liquid crystal display panel and the display device 100 may be a liquid crystal display device.

Referring to FIGS. 1 and 2A, the display panel 110 included in the display device 100 according to example embodiments may be a foldable display panel. Alternatively, the display panel 110 may be a bended display panel, a flexible display panel, etc. The display panel 110 may include at least one folding area FA and at least one non-folding area NFA. The folding area FA may be disposed between the non-folding areas NFA. The display panel 110 may include a display surface DA on which an image is displayed and a non-display surface NDA which an image is not displayed. The display panel 110 may be folded inward or outward around the folding area FA.

Referring to FIG. 2B, the display panel 110 may be folded inward so that the display surface DA overlaps itself. For example, the display panel 110 may be folded inwardly around the folding area FA so that surfaces of the non-folding areas NFA, upon which the display area. DA is disposed, face one another, and the non-display surface NDA is outwardly exposed. Referring to FIG. 2C, the display panel 110 may be folded outwardly about the folding area FA so that the display surface DA faces outwardly. As a count of the number of times the folding area FA is folded increases, stress may be incurred by the folding area FA. Stresses that occur due to repeated folding decrease efficiency of the pixels PX formed in the folding area FA and the luminance of the pixels PX formed in the folding area FA is also decreased. The display device 100 according to exemplary embodiments of the present inventive concept increases display quality by generating compensation data Vc that adjusts luminance of the pixels PX formed in the folding area FA based upon the count of the number of times the folding area FA has been folded.

Referring back to FIG. 1, the timing controller 120 may convert a first image data DATA1 provided from an external device to a second image data DATA2 and generate a scan control signal CTL_S and a data control signal CTL_D that control the second image data DATA2. The timing controller 120 may generate a compensation control signal CTL_C that controls the folding area compensator 130. The timing controller 120 may convert the first image data DATA1 to the second image data. DATA2 by applying an algorithm (e.g., dynamic capacitance compensation (DCC)) that compensates for altered display quality of the first image data DATA1. When the timing controller 120 does not include the algorithm that compensates for altered display quality, the timing controller 120 may output the first image data DATA1 as the second image data DATA2. The timing controller 120 may receive the control signal CON from an external device and generate the scan control signal CTL_S, provided to the scan driver 150, the data control signal CTL_D provided to the data driver 140, and the compensation control signal CTL_C provided to the folding area compensator 130. For example, the scan control signal CTL_S may include a vertical start signal and at least one clock signal. The data control signal CTL_D may include a horizontal start signal and at least one clock signal.

The folding area compensator 130 may generate the compensation data Yc that adjusts luminance of the folding area FA based upon the count of the number of times the folding area FA has been folded and sensing data of the folding area FA. For example, the compensation data Yc generated by the folding area compensator 130 may adjust the luminance of the pixels PX formed in the folding area FA.

According to exemplary embodiments of the present inventive concept, the folding area compensator 130 may generate the compensation Yc based upon a luminance change rate previously stored when the count of the number of times the folding area FA has been folded reaches a predetermined reference number. The folding area compensator 130 may include a first storage unit that stores the data associated with the luminance Change rate corresponding to the reference folding number. For example, the first storage unit may be implemented as a lookup table (LUT). The folding area compensator 130 may sense whether the folding area FA is folded and may update the count of the number of times the folding area FA has been folded the second storage unit. The folding area compensator 130 may generate the compensation data Vc when the count of the number of times the folding area FA has been folded reaches the reference folding number. The folding area compensator 130 may read the luminance change rate corresponding to the reference folding number using the first storage unit and generate the compensation data Vc that compensates for the luminance change rate when the count of the number of times the folding area FA has been folded reaches the reference folding number.

According to exemplary embodiments of the present inventive concept, the folding area compensator 130 may generate the compensation data Vc based upon the luminance change rate and a current change rate. The folding area compensator 130 may sense a current flowing through the pixels PX formed in the folding area FA when the count of the number of times the folding area FA has been folded reaches a reference folding number stored in the first storage unit. The folding area compensator 130 may calculate the current change rate based on an initial current flowing through the pixels PX formed in the folding area FA during initial operation of the display panel 110 the current flowing through the pixels PX funned in the folding area FA when the count of the number of times the folding area FA has been folded reaches the reference folding number. The folding area compensator 130 may generate the compensation data Vc that compensates for the current change rate when the preset luminance change rate and the current change rate are not the same value. The folding area compensator 130 may measure the current flowing through the pixels PX formed in the folding area FA and may generate the compensation data Vc based upon the current change rate when the count of the number of times the folding area FA has been folded reaches the reference folding number. The compensation data Vc may compensate for the luminance change in the folding area FA.

The folding area compensator 130 may output the compensation data Vc to the data driver 140.

The data driver 140 may generate the data voltage Vdata based on the second image data. DATA2 and the compensation data Vc. The data driver 140 may provide the data voltage Vdata to the pixels PX through the data lines DL based upon the data control signal CTL_D.

According to exemplary embodiments of the present inventive concept, the folding area compensator 130 may be connected to the data driver 140. However, the present inventive concept is not limited thereto. For example, the folding area compensator 130 may be disposed within the data driver 140.

The scan driver 150 may provide the scan signal SCAN to the pixels PX through the scan lines SL. The scan driver 150 may generate the scan signal SCAN based on the scan control signal CTL_S provided from the timing controller 120.

As described above, the display device 100 of FIG. 1 may compensate for a difference in the luminance of the folding area FA by generating the compensation data Vc based upon the luminance change rate associated with a reference folding number when the count of the number of times the folding area FA has been folded reaches one of the reference folding numbers. The display device 100 of FIG. 1 may also compensate for a decrease in the luminance of the folding area FA by sensing the current flowing through the pixels PX formed in the folding area when the count of the number of times the folding area FA has been folded reaches one of the reference folding numbers, calculating the current change rate, and generating the compensation data Vc based upon the current change rate when the luminance change rate and the current change rate are not the same value. Thus, the display quality of the display device 100 may be Unproved.

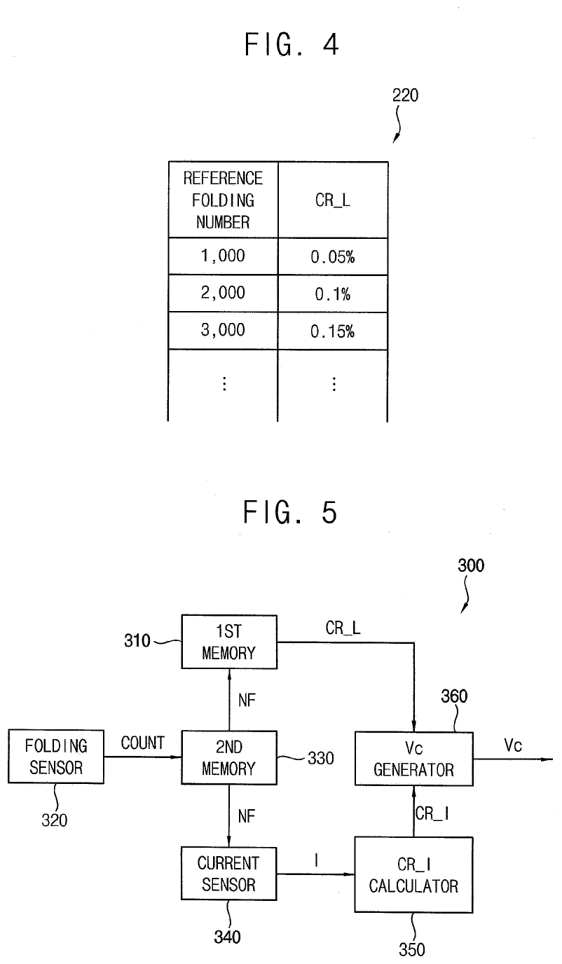

FIG. 3 is a block diagram illustrating an a folding area compensator included in the display device of FIG. 1 according to an exemplary embodiment of the present inventive concept. FIG. 4 is a diagram illustrating a first storage unit included in the folding area compensator of FIG. 3 according to an exemplary embodiment of the present inventive concept.

Referring to FIG. 3, a folding area compensator 200 may include a first memory (which may also be referred to herein as a first storage unit) 220, a folding sensor 240, a second memory (which may also be referred to herein as, a second storage unit) 260, and a Vc generator (which may also be referred to herein as a compensation data generator) 280. The folding area compensator 200 of FIG. 3 may correspond to the folding area compensator 130 depicted in FIG. 1.

Referring to FIG. 4, the first storage unit 220 may store a preset luminance Change rate CR_L corresponding to a predetermined reference folding number. For example, the first storage unit 220 may refer to a storage device configured as a data repository such as a non-volatile memory device. The preset luminance Change rate CRL corresponding to the reference folding number may be experimentally derived. The first storage unit 220 may include a lookup table. The first storage unit 220 may store the preset luminance change rate CR_L of the folding area obtained every time the folding area FA is folded a predetermined number of times, for example, every 1000 times. The preset luminance change rate CR_L corresponding to the reference folding number may be stored in a manufacturing process of the display device as a preset percent of change.

The folding sensor 240 may be configured to sense when the folding area FA is folded. The folding sensor 240 may determine that the folding area FA is folded by recognizing a folding angle of the folding area FA. For example, the folding sensor 240 may include a an acceleration sensor, a pressure sensor, a strain gauge, etc. The folding sensor 240 may output a counting signal COUNT to the second memory 330 when the folding area FA is changed by a predetermined angle or more.

The second memory 260 may transmit the count of the number of times the folding area has been folded NF to the first memory 220 based upon the counting signals COUNT provided by the folding sensor 240. According to exemplary embodiments of the present inventive concept, the second memory 260 may update the count of the number of times the folding area has been folded NF by accumulating the individual counting signals COUNT received from the folding sensor 240. The second memory 260 may transmit the count of the number of times the folding area has been folded NE to the first memory 220 by accumulating the counting signals COUNT received from the folding sensor 240, and may transmit the count of the number of times the folding area has been folded NF to the first memory 220 when a predetermined reference folding number is achieved. For example, when the reference folding number is 1000 folds and the folding area FA is folded 1000 times, the second storage unit 260 may proceed to transmit the count of the number of times the folding area has been folded NF to the first memory 220.

The compensation data generator 280 may generate the compensation data based upon the preset luminance change rate CR_L corresponding to the reference folding number using the first memory 220 when the count of the number of times the folding area has been folded reaches the reference folding number. For example, when the count of the number of times the folding area has been folded NF stored in the second storage unit 260 reaches 1000 folds, the compensation data generator 280 may read the preset luminance change rate CR_L 0.05% corresponding to the reference folding number 1000 stored in the first storage unit 220 described in FIG. 4. The compensation data generator 280 may generate the compensation data Vc that adjusts the luminance of the pixels in the folding area FA based upon the preset luminance change rate CR_L. The compensation data Yc may be data that prompts the data driver 140 to increase a voltage level of the data voltage Vdata to be provided to the pixels PX in the folding area FA. The compensation data generator 280 may provide the compensation data Vc to the data driver 140.

As described above, the folding area compensator 200 included in the display device according to exemplary embodiments of the present inventive concept may store the preset luminance change rate CR_L corresponding to the reference folding number and generate the compensation data Vc that adjusts the preset luminance change rate CR_L when the count of the number of times the folding area has been folded NF reaches the reference folding number so that the luminance of pixels in the folding area may be adjusted.

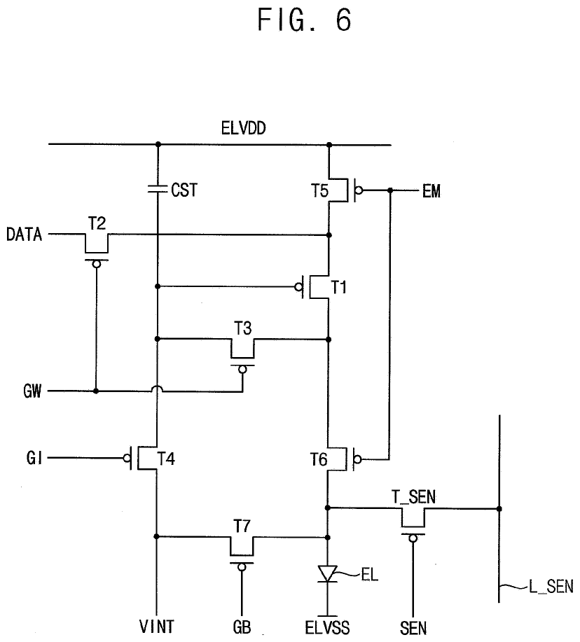

FIG. 5 is a block diagram illustrating a folding area compensator depicted in the display device of FIG. 1 according to an exemplary embodiment of the present inventive concept. FIG. 6 is a circuit diagram illustrating a pixel included in the display panel of the display device of FIG. 1 according to an exemplary embodiment of the present inventive concept.

Referring to FIG. 5, a folding area compensator 300 may include a first memory (herein also referred to as a first storage unit) 310, a folding sensor 320, a second memory (herein also referred to as a second storage unit) 330, a current sensor 340, a current change rate (CR_I) calculator 350, and a Vc generator (herein also referred to as a compensation data generator) 360. According to an exemplary embodiment of the present inventive concept, the folding area compensator 300 of FIG. 5 may correspond to the folding area compensator 130 of FIG. 1.

Referring to FIG. 5, the first storage unit 310 may store a preset luminance change, rate CR_L corresponding to a predetermined reference folding number. The preset luminance change rate CR_L corresponding to the reference folding number may be experimentally derived. The first storage unit 310 may be implemented, as a lookup table. For example, the first storage unit 310 may store the preset luminance change rate CR_L of the folding area corresponding to a predetermined number of times the folding area FA is folded, such as intervals of 1000 folds. The preset luminance change rate CR_L corresponding to the reference Melding number may be stored it a manufacturing process of the display device.

The folding sensor 320 may sense when the folding area FA is folded. The folding sensor 320 may determine that the folding area FA is folded by recognizing a predetermined folding angle or angle range experienced by the folding area FA, For example, the folding sensor 320 may include a sensor such as an acceleration sensor, a pressure sensor, a strain gauge, etc. The folding sensor 320 may output a counting signal COUNT when the folding area FA is changed by a predetermined angle or more, or within a designated folding angle range.

The second storage unit 330 may update and store the count of the number of times the folding area has been folded NF based upon the counting signals COUNT provided by the folding sensor 320. According to an exemplary embodiment of the present inventive concept, the second storage unit 330 may update the count of the number of times the folding area has been folded NF by accumulating the counting signals COUNT provided by the folding sensor 320. In other exemplary embodiments of the present inventive concept, the second storage unit 330 may update the count of the number times the folding area has been folded NF by accumulating the counting signals COUNT provided by the folding sensor 320 and transmit the count of the number of times the folding area has been folded NF when the count of the number of times the folding area has been folded NF reaches the predetermined reference folding number. For example, when the reference folding number is 1000 and the folding area FA is folded 1000 times (1000 counting signals COUNT transmitted by the folding sensor 320 to the second storage unit 330, the second storage unit 330 may transmit the count of the number of times the folding area has been folded NF.

The current sensor 340 may sense a current flowing through the pixels PX formed in the folding area FA when the count of the number of times the folding area has been folded NF reaches a reference folding number. Referring to FIG. 6, each of the pixels PX formed in a pixel area of the folding area FA may include first through seventh transistors T1, T2, T3, T4, T5, T6, T7 and a storage capacitor CST that generates a driving current to drive the organic light emitting diode EL, and a sensing transistor T_SEN to sense a current flowing through the organic light emitting diode EL, The first transistor T1 may generate a driving current according to a voltage corresponding to a data voltage DATA. The second transistor 12 may turn on in response to a first scan signal GW and transfer the data voltage DATA to the storage capacitor CST through the third transistor T3. The third transistor T3 may turn on in response to the first scan signal GW and transfer the data voltage DATA to the storage capacitor CST. The fourth transistor may turn on in response to a second scan signal GI and transfer an initial voltage VINT to a gate electrode of the first transistor T1. The fifth transistor T5 and the sixth transistor T6 may turn on in response to an emission control signal EM and providing a first power voltage ELVDD to the organic light emitting diode EL. The seventh transistor T7 may turn on in response to a third scan signal GB and transfer the initial voltage VINT to an anode electrode of the organic light emitting diode EL. The organic light emitting diode may include the anode electrode coupled to the sixth transistor T6 and a cathode electrode that receives a second power voltage ELVES. The organic light emitting diode may emit light based on the driving current provided through the sixth transistor T6, The sensing transistor T_SEN may be coupled to a sensing line SL. The current sensor 340 may provide a sensing signal SEN to the sensing transistor T_SEN. When the sensing transistor T_SEN is a P-channel metal oxide semiconductor (PMOS) transistor, the sensing transistor T_SEN may turn on in response to the sensing signal SEN having a low level. When the sensing signal SEN having the low level is provided to the sensing transistor T_SEN, the sensing transistor T_SEN may turn on and the current flowing through the organic light emitting diode EL may be detected. For example, the current sensor 340 may detect the current flowing through each of the pixels PX by providing the sensing signal SEN to the sensing transistor T_SEN during a power on period and a vertical blank period during which the image is not displayed on the display panel. According to an exemplary embodiment of the present inventive concept, the current sensor 340 may detect the current of all pixels PX formed in the folding area FA of the display panel 110. According to another exemplary embodiment of the present inventive concept, the current sensor 340 may detect the current of individual pixels PX formed in the folding area FA of the display panel 110 or a representative sample of pixels PX. For example, the current sensor 340 may detect the current flowing through one of the pixels PX formed in the folding area FA, or detect the current flowing through the pixels PX coupled to one of the data lines DL formed in the folding area FA.

The current change rate CR_I calculator 350 may calculate a current change rate CR_I based on an initial current flowing through the pixels PX formed in the folding area FA and a current detected in the current sensor 340. The initial current may be measured and stored during the manufacturing process of the display device 100. The current flowing through the pixels PX formed in the folding area FA may decrease because the pixels PX are degraded due to the stress applied to the pixels PX in the folding area FA. The current change rate CR_I calculator 350 may calculate the current change rate CR_I that indicates how much the current of the pixel PX, measured from when the count of the number times the folding area has been folded NF of the folding area FA has reached a reference folding number: has changed from the initial current.

The compensation data generator 360 may generate the compensation data Vc based upon the preset luminance change rate CR_L and the current change rate CR_I. The compensation data generator 360 may generate the compensation data Vc based on the preset luminance change rate CR_L read from the first storage unit 310 and the current change rate CR_I calculated by the current change rate CR_I calculator 350 when the count of the number of times the folding area has been folded NF readies a reference folding number. The compensation data generator 360 may generate the compensation data Vc that adjusts the luminance based upon the preset luminance change rate CR_L when the preset luminance change rate CR_L and the current change rate CR_I are the same. For example, if a preset percentage change in luminance reflected in the preset luminance change rate CR_L is the same as the current change rate CR_I, as measured from an initial reference point, the compensation data generator 360 may generate compensation data Vc. However, the preset luminance change rate CR_L and the current change rate CR_I might not be the same according to characteristics of the display panel 110. The preset luminance change rate CR_L might not reflect the characteristics of the display panel 110 because the preset luminance change rate CR_L is a value experimentally measured and stored based on a limited number of the display panels 110. For example, when the luminance of the display panel 110 is low or high due to a process dispersion of the display panel, the preset luminance change rate CR_L and the current change rate CR_I might not be the same value. Alternatively, the preset luminance change rate CR_L and the current change rate CR_I might not be the same due to a difference of degradation speed of the pixels PX. The compensation data generator 360 may generate the compensation data Vc that compensate for the current change rate CR_I when the preset luminance change rate CR_L and the current change rate CR_I are not the same. For example, the compensation data Vc may normalize the current supplied to a pixel PX when the preset luminance change rate CR_L and the current change rate CR_I are not the same.

According to exemplary embodiments of the present inventive concept as described above, the folding area compensator 300 of the display device 100 may store the preset luminance change rate CR_L corresponding to the reference folding number, calculate the current change rate CR_I by measuring the current flowing through the pixels PX formed in the folding area FA when count of the number of times the folding area has been folded NF reaches the reference folding number, and generates the compensation data Vc based upon the preset luminance change rate CR_L and the current change rate CR_I. Thus, the luminance of the folding area may be adjusted according to the dispersion of the display panel 110.

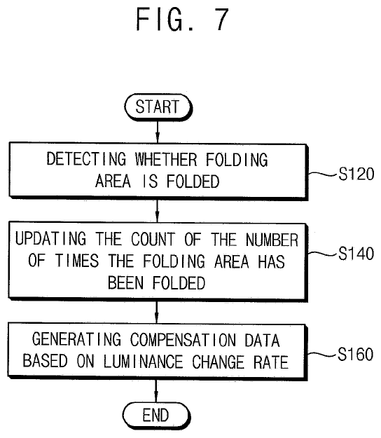

FIG. 7 is a flowchart illustrating a driving method of the display device according an exemplary embodiment of the present inventive concept.

Referring to FIG. 7, a driving method of a display device may include an operation of detecting whether a display panel is folded S120, an operation of updating the count of the number of times the folding area FA has been folded S140, and an operation of generating compensation data based on a luminance change rate S160.

The driving method of the display device may detect whether the display panel that includes a folding area and a non-folding area is folded S120. A foldable display device, a beaded display device, a flexible display device, etc. may include the display panel that includes the folding area and the non-folding area. The display panel may include at least one folding area and the non-folding area. The folding area may be disposed between the non-folding areas. The driving method of the display device may detect whether the folding area is folded using a folding sensor. The folding sensor may determine that the folding area is folded by recognizing a folding angle. For example, the folding sensor may include a sensor such as an acceleration sensor, a pressure sensor, a strain gauge, etc.

The driving method of the display device may update the count of the number of times the folding area has been folded S140. The count of the number of times the folding area has been folded may be updated and stored in a second storage unit. The second storage unit may update the number of times a folding area has been folded based upon counting signals provided from the folding sensor. According to an exemplary embodiment of the present inventive concept, the second storage unit may update the count of the number of times the folding area has been folded by accumulating the counting signals provided from the folding sensor. In other example embodiments, the second storage unit may update the number of times the folding area has been folded by accumulating the counting signals provided from the folding sensor and transmitting the count of the number of times the folding area has been folded when the count of the number of times the folding area has been folded reaches the reference folding number.

The driving method of the display device may generate the compensation data that adjusts the luminance of the folding area based on the luminance change rate corresponding to a reference folding number when the count of the number times the folding area has been folded reaches a reference folding number S140. The luminance change rate corresponding to the reference folding number may be stored in the first storage unit. For example, the first storage unit may include a lookup table. The driving method of the display device may read the luminance change rate corresponding to the reference folding, number stored in the first storage unit when the count of the number of times the folding area has been folded reaches a reference folding number. The driving method of the display device may generate the compensation data that increases a voltage level of a data voltage to be provided to the pixels in the folding area based upon the luminance change rate.

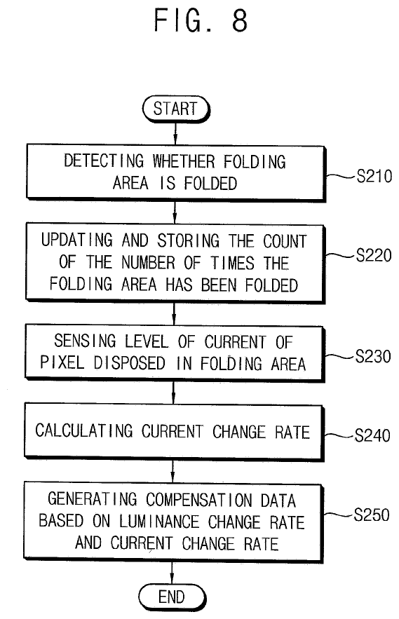

FIG. 8 is a flowchart illustrating a driving method, of the display device according to exemplary embodiments of the present inventive concept.

Referring to FIG. 8, a driving method of a display device may include an operation of detecting whether a folding area is folded S210, an operation of updating and storing the count of the number of times the folding area has been folded S220, an operation of sensing a level of current provided to a pixel disposed in the folding area S230, an operation of calculating the current change rate S240, and an operation of generating compensation data based on a luminance change rate and the current change rate S250.

The driving method of the display device may detect whether the display panel that includes a folding area and a non-folding area is folded S210. A foldable display device, a bended display device, a flexible display device, etc. may include the display panel that includes the folding area and the non-folding area. The display panel may include at least one folding area and the non-folding area. The folding area may be disposed between the non-folding areas. The driving method of the display device may detect whether the folding area is folded using a folding sensor. The folding sensor may determine that the folding area is folded by recognizing a folding angle. For example, the folding sensor may include a sensor such as an acceleration sensor, a pressure sensor, a strain gauge, etc.

The driving method of the display device may store the count of the number of times the folding area has been folded S220. The count of the number of times the folding area has been folded may be updated and stored in a second storage unit. The second storage unit may update the count of the number of times the folding area has been folded based upon a counting signal provided from the folding sensor. According to exemplary embodiments of the present inventive concept, the second storage unit may update the count of the number of times the folding area has been folded by accumulating the counting signals provided from the folding sensor. The second storage unit may store the count of the number of times the folding area has been folded by accumulating the counting signals provided from the folding sensor and transmitting the count of the number of times the folding area has been folded when the number of times the folding area has been folded reaches a reference folding number.

The driving method of the display device may sense the current flowing through the pixels formed in the folding, area when the count of the number of times the folding area has been folded reaches a reference folding number S230. For example, the pixels formed in the folding area may include sensing transistors and the current flowing through the pixels may be detected through the sensing line when the sensing transistor turns on. According to an exemplary embodiment of the present inventive concept, the sensing transistor may turn on when the count of the number times the folding area has been folded reaches a reference folding number.

The driving method of the display device may calculate the current change rate based upon an initial current flowing through the pixels formed in the folding area and the current flowing through the pixels formed in the folding area when the count of the number of times the folding area has been folded reaches the reference folding number S240. The initial current may be measured and stored during the manufacturing process of the display device. The current change rate may indicate how much smaller the current of the pixel measured from when the count of the number of times the folding area has been folded reaches a reference folding number is than the initial current.

The driving method of the display device may generate the compensation data based on the preset luminance change rate and the current change rate S250. The driving method of the display device may generate the compensation data that compensates for the preset luminance change rate by adjusting the luminance of the folding area when the luminance change rate and the current change rate are the same value. The driving method of the display device may generate the compensation data that compensates for the current change rate when the luminance change rate and the current change rate are not the same value.

The present inventive concept may be applied to a display device and an electronic device having the display device. For example, the present inventive concept may be applied to a computer monitor, a laptop, a digital camera, a cellular phone, a smart phone, a smart pad, a television, a personal digital assistant (PDA), a portable multimedia player (PMP), a MP3 player, a navigation system, a game console, a video phone, etc.

While exemplary embodiments of the present inventive concept have been shown and described above, it will be understood by one of ordinary skill in the art that variations in form and detail may be made therein without departing from the spirit and scope of the present disclosure as defined by the appended claims.

What is claimed is:

1. A display device comprising:
a display panel including a folding area and a non-folding area;
a data driver configured to provide a data voltage to the display panel;
a gate driver configured to provide a gate signal to the display panel;
a folding area compensator configured to generate compensation data that adjusts luminance of pixels formed in the folding area based upon a count of the number of times the folding area has been folded and a level of current flowing through a pixel formed in the folding area; and
a timing controller configured to generate a control signal that controls the data driver, the gate driver, and the folding area compensator.

2. The display device of claim 1, wherein the folding area compensator includes:
a first storage unit configured to store a preset luminance change rate of the folding area corresponding to a predetermined reference folding number;
a folding sensor configured to sense whether the folding area is folded; and
a second storage unit configured to store the count of the number of times the folding area has been folded.

3. The display device of claim 2, wherein the folding area compensator includes a compensation data generator configured to generate the compensation data based upon the preset luminance change rate corresponding to the reference folding number when the count of the number of times the folding area has been folded reaches the reference folding number.

4. The display device of claim 2, wherein the first storage unit includes a lookup table (LUT).

5. The display device of claim 2, wherein the folding area compensator includes:
a current sensor configured to sense the current flowing through at least one pixel formed in the folding area when the count of the number of times the folding area has been folded reaches the reference folding number; and
a current change rate calculator configured to calculate a current change rate based on an initialization current flowing through the pixels formed in the folding area and the current.

6. The display device of claim 5, wherein the folding area compensator includes a compensation data generator configured to generate the compensation data based upon the preset luminance change rate corresponding to the reference folding number and the current change rate.

7. The display device of claim 6, wherein the compensation data generator generates the compensation data based upon the current change rate when the luminance change rate is not the same as the current change rate.

8. The display device of claim 5, wherein the current sensor senses the current flowing through a part of the pixels formed in the folding area.

9. The display device of claim 5, wherein the current sensor senses the current flowing through all of the pixels formed in the folding area.

10. The display device of claim 1, wherein the data driver generates the data voltage based upon the compensation data.

11. The display device of claim 1, wherein the compensation data changes a voltage level of the data voltage provided to the pixel formed in the folding area.

12. The display device of claim 1, wherein the folding area compensator is coupled to the data driver.

13. The display device of claim 1, wherein the folding area compensator is disposed in the data driver.

14. A driving method of a display device comprising:
sensing whether a display panel that includes a folding area and a non-folding area is folded;
updating a count of the number of times the folding area has been folded; and
generating a compensation data that adjusts luminance of the folding area based upon a preset luminance change rate corresponding to a reference folding number when the count of the number of times the folding area has been folded reaches the reference folding number.

15. The driving method of claim 14, wherein the luminance change rate corresponding to the reference folding number is stored in a first storage unit and the count of the number of times the folding area has been folded is updated to a second storage unit.

16. The driving method of claim 15, wherein the first storage unit includes a lookup table (LUT).

17. The driving method of claim 14, further comprising:
sensing a current flowing through the pixels formed in the folding area when the count of the number of times the folding area has been folded reaches the reference folding number; and
calculating a current change rate based on an initialization current flowing through the pixels formed in the folding area and the current.

18. The driving method of claim 17, wherein generating the compensation data includes generating the compensation data based upon the preset luminance change rate corresponding to the reference folding number and the current change rate.

19. The driving method of claim 18, wherein generating the compensation data generates the compensation data based upon the current change rate when the preset luminance change rate and the current change rate are different values.

20. A system for driving a display device comprising:
a folding area compensator configured to connect to a data driver and a timing controller of a display device,
wherein the folding area compensator comprises:
a sensor configured to detect when a folding area is folded based upon a predetermined angle or angle range, and transmit each fold occurrence to a first memory device; and
the first memory device is configured to update a count of the number of times the folding area is folded and transmit a signal to a current sensor upon achieving a count of the number of times the folding area is folded that corresponds to a predetermined reference number,
wherein the current sensor comprises a sensing transistor coupled to a pixel and a sensing line, and the sensing line is configured to provide a sensing signal to the sensing transistor,
wherein the sensing transistor is configured to detect current flowing through an organic light emitting diode of the pixel, and
wherein the folding area compensator prompts the data driver to release a compensation voltage when the current detected is different from an initial current.
